(19) United States
(12) Patent Application Publication
(10) Pub. No.: US 2025/0359686 A1
(43) Pub. Date: Nov. 27, 2025

(54) TENSIONING STRUCTURE FOR AN INFLATABLE PRODUCT

(71) Applicant: Intex Marketing Ltd., Tortola (VG)

(72) Inventors: Zhi Xiong Huang, Fujian (CN); Qing Feng Zheng, Fujian (CN); Guang Zhou Gao, Fujian (CN)

(73) Assignee: Intex Marketing Ltd., Tortola (VG)

(21) Appl. No.: 18/873,606

(22) PCT Filed: Jun. 14, 2023
(86) PCT No.: PCT/US2023/025268

§ 371 Date: Dec. 10, 2024

Related U.S. Application Data
(60) Provisional application No. 63/414,220, filed on Oct. 7, 2022.
(60) Provisional application No. 63/414,375, filed on Oct. 7, 2022.

(30) Foreign Application Priority Data
Jun. 14, 2022 (CN) 202210673323.1
Jun. 14, 2022 (CN) 202221488892.0
Jun. 14, 2022 (CN) 202221497339.3

(51) Int. Cl. A47C 27/08; B68G 7/12

(52) U.S. Cl. CPC A47C 27/087; A47C 27/081; B68G 7/12

(57) ABSTRACT

A strand-based tensioning structure for inflatable products has improved strength and durability. The tensioning structure includes fine-diameter, high-strength multifilament threads adapted to reconfigure into a flattened and/or spread out within the weld strip(s) to which the strands are attached. This flattening, combined with the fine diameter of the strands welded material, allows the threads to become thoroughly integrated within the weld strip material after welding, promoting a high-strength interface between the weld strip and the threads. Additionally, the material of the weld strip itself is left substantially intact to promote a high-strength interface between the weld strip and the outer sheets to which the tensioning structure is fixed. An adhesive may also be integrated into the multifilament threads to further strengthen the weld strip/thread fixation upon welding.

### CROSS-REFERENCE TO RELATED APPLICATIONS

This application claims the benefit of U.S. Provisional Application No. 63/414,220, filed Oct. 7, 2022, titled TENSIONING STRUCTURE FOR AN INFLATABLE PRODUCT and U.S. Provisional Application No. 63/414,375, filed Oct. 7, 2022, titled TENSIONING STRUCTURE FOR AN INFLATABLE PRODUCT and claims priority to CN202210673323.1, filed Jun. 14, 2022 and entitled “A tension belt structure of an inflatable product,” CN202221488892.0, filed Jun. 14, 2022 and entitled “A tension belt structure of an inflatable product,” and CN202221497339.3, filed Jun. 14, 2022 and entitled “A thread structure,” the entire disclosures of which are hereby expressly incorporated herein by reference.

### BACKGROUND

### 1. Technical Field

The present disclosure relates to a tensioning structure, for, e.g., an inflatable product structure, and in particular to a tensioning structure which can be used in an inflatable product structure which is light in weight and low in cost.

### 2. Description of the Related Art

Inflatable products, are lightweight and easy to store and transport. Such products technologies have been used for outdoor items and toys, as well as various household goods including inflatable beds, inflatable sofas and the like. Inflatable pools, spas and other water-containing structures are also offered in the marketplace.

Many inflatable products utilize internal structures in order to form the product into its intended, predetermined shape upon inflation. For example, one type of inflatable bed, referred to as a wave-shaped, straight-strip or I-shaped inflatable bed, may include a tension-band type internal structure arranged along wave-shaped, straight-line or I-shaped pathways within the internal cavity, respectively. Another type of inflatable bed, referred to as a column-type inflatable bed, has tension bands arranged into honeycomb-shaped or cylindrical structures within the inflatable cavity.

Spas and pools may also use internal tensioning structures which extend from an outer wall to an inner wall, helping to form a “doughnut” or annulus structure capable of holding a volume of water. Such tensioning structures are typically arranged around the periphery of the pool or spa and extend along straight linear paths radially outwardly.

Internal tensioning structures disposed in the cavity of the inflatable product give shape to the product as internal pressure increases, thereby preventing the inflatable product from expanding evenly on all sides in the manner of a balloon. For example, in order to maintain an inflatable bed as a rectangular shape, its tensioning structures join the upper and lower sheets of the inflatable bed to one another. To allow passage of pressurized air to both sides of these joining structures, the tensioning structures may be formed as belts stretching between the upper and lower surfaces, or as vertical expanses of material with air columns formed therein. The number and spacing of the tensioning structures is proportional to the sharpness of the rectangularity of the inflated product. That is to say, a greater number and/or linear extent of tensioning structures within the pressurized cavity results in a more “flat” bed surface.

In some inflatable products such as the inflatable beds described above, the tension bands are made of solid, PVC-only sheets with a sufficient thickness to ensure spreading of force and concomitant reductions in stress in the product material. For example, the tension bands of certain inflatable beds or sofas may have a thickness of about 0.36 mm. For some known water carrier devices, such as inflatable swimming pools, the internal tension bands may have a thickness of about 0.38 mm, while “sandwich” type inflatable swimming pools may have a thickness of 0.7-0.8 mm.

Other, more modern inflatable structures use strands, such as strings, wires threads or filaments, to span the gap between two or more components of the inflatable structure. The strands connect to weld strips or sheets, which in turn are connected to the two or more components. When the product is inflated, the threads are placed in tension to bear most of all of the forces bome by the tensioning structures, thereby enabling substantial reductions in the amount of PVC needed for the overall tensioning structure. While these more modern inflatable structures are a significant improvement over other designs, consumers desire inflatable products that are even lighter, stronger and more durable.

### SUMMARY

The present disclosure provides a strand-based tensioning structure for inflatable products with improved strength and durability. The tensioning structure includes fine-diameter, high-strength multifilament threads adapted to reconfigure into a flattened and/or spread out within the weld strip(s) to which the strands are attached. This flattening, combined with the fine diameter of the strands welded material, allows the threads to become thoroughly integrated within the weld strip material after welding, promoting a high-strength interface between the weld strip and the threads. Additionally, the material of the weld strip itself is left substantially intact to promote a high-strength interface between the weld strip and the outer sheets to which the tensioning structure is fixed. An adhesive may also be integrated into the multifilament threads to further strengthen the weld strip/thread fixation upon welding.

The present disclosure may provide a tensioning structure for an inflatable product. The tensioning structure includes a first weld strip, a second weld strip spaced from the first weld strip to define a gap therebetween, and a plurality of strands arranged between the first and second weld strips and spanning the gap. The plurality of strands may each have a first end portion fixed to the first weld strip and a second, opposing end portion fixed to the second weld strip. Each of the plurality of strands may include at least two filaments. Each of the filaments may include at least two yarns. Each of the plurality of strands may have an undeformed portion spanning the gap between the first and second weld strips and a deformed portion at the first and second end portions. The undeformed portion may define a strand diameter and the deformed portion defining a width that is greater than the strand diameter.

Optionally, the width of the strand at the first and second ends portions is between 1.2 and 5.0 times the strand diameter.

Optionally, the filaments are parallel to one another in the undeformed portion and dispersed in the deformed portion.

Optionally, the second weld strip is substantially parallel to the first weld strip, and the plurality of strands each have a substantially equal length.

Optionally, the plurality of strands and the first and second weld strips are generally coplanar when the tensioning structure is laid flat.

Optionally, at least some of the filaments are helically parallel, and a degree of twist between the helically parallel filaments is up to 50 twists per meter.

Optionally, the strand and the weld strip form a welded product.

Optionally, the tensioning structure further comprises an adhesive layer configured to become molten and flowable when the weld strips are fixed to the plurality of strands. The adhesive layer may be applied to at least one of the first the weld strip and the second weld strip. The adhesive layer may be coated over the strand. The filaments may be linearly parallel, such that a twist degree between the filaments is zero. The adhesive layer may be coated individually on each of the filaments. The filaments may be wound, such that at least some of the filaments are helically parallel.

Optionally, the filaments define between 50 and 1,000 Decitex (dtex).

Optionally, each of the plurality of strands has a denier between 50 and 2,500.

Optionally, the strand further includes an adhesive layer configured to become molten and flowable when the weld strips are fixed to the plurality of strands. The adhesive layer may be hot-melt glue. The adhesive layer may be volatile glue. The adhesive layer may be one of PVC cement or PU adhesive.

Optionally, the plurality of strands are evenly spaced and substantially parallel.

Optionally, the plurality of strands are connected end to end to form a shape of “V”, and the upper and lower parts of each “V” shape strand are fixed together with the first and second weld strips, respectively.

Optionally, a weld sheet may be included having the plurality of strands fixed to a surface of the weld sheet along the undeformed portion.

Optionally, the filaments of the strand are arranged in parallel to form an M×N array, where M and N are each integers equaling 1 or more. Optionally. M equals 1 or 2, N≥2 when M=1, and N≥1 when M=2. The filaments may be twisted and helically parallel, with a degree of twist up to 1,000 twists per meter. The filaments may be linearly parallel. The filaments may define between 50 and 1,000 Decitex (dtex). Each of the plurality of strands may have a denier between 50 and 2,500. Optionally, a thickness of the adhesive layer may be between 0.01 mm and 0.5 mm.

Optionally, the strand further comprises an adhesive layer configured to become molten and flowable when the weld strips are fixed to the plurality of strands. The thickness of the adhesive layer may between 0.01 mm and 0.5 mm.

The present disclosure may provide a method of making a tensioning structure, including abutting a first end portion of each of a plurality of strands against a first weld strip, abutting a second, opposing end portion of each of the plurality of strands against a second weld strip spaced from the first weld strip to define a gap therebetween, compressing the first end portion and the second end portion of the strands against the first weld strip and the second weld strip respectively, and heating the weld strips and the compressed first and second end portions of the plurality of strands to fix the first and second end portions to the first and second weld strips respectively. At least one of the steps of compressing and heating may cause multiple filaments of the first and second end portions of the strands to deform and disperse, such that the first and second end portions define a width larger than an undeformed portion of each of the strands spanning the gap.

Optionally, the plurality of strands each includes an adhesive layer, and the step of heating the weld strips also heats the adhesive layer such that the adhesive layer intermixes and integrates with the material of the weld strips in the vicinity of the interface between the filaments and the adjacent weld strip surface.

Optionally, at least one of the weld strips includes an adhesive layer, and the step of heating the weld strips also heats the adhesive layer such that the adhesive layer intermixes and integrates with the material of the strands in the vicinity of the interface between the filaments and the adjacent weld strip surface.

Optionally, a width of the deformed portion of each of the strands is between 1.2 and 5.0 times a diameter of the undeformed portion of the strand.

Optionally, the filaments are parallel to one another in the undeformed portion and dispersed in the deformed portion.

Optionally, the step of heating includes activating a welder to soften or melt the weld strips.

Optionally, the welder has an operating frequency between 10 MHz and 40 MHz. The step of compressing may include creating an operating pressure intensity between 1 kgf/cm² and 100 kgf/cm² on the weld strips and the end portions of the plurality of strands.

### BRIEF DESCRIPTION OF THE DRAWINGS

The above mentioned and other features of this invention, and the manner of attaining them, will become more apparent and the invention itself will be better understood by reference to the following description of embodiments of the invention taken in conjunction with the accompanying drawings, where:

FIG. 1 is a schematic, cross-sectional view of a multifilament strand fixed between weld strips in a prior tensioning structure;

FIG. 2 is a perspective view of a multifilament strand used in accordance with the prior tensioning structure of FIG. 1;

FIG. 3A is an elevation view of a prior tensioning structure in accordance with FIG. 1;

FIG. 3B is an enlarged, side elevation view of a portion of the prior tensioning structure shown in FIG. 3A;

FIG. 3C is a cross-section view, taking along the line 3C-3C of FIG. 3B, of the prior tensioning structure shown in FIG. 3A;

FIG. 4 is a perspective view of a multifilament strand used in tensioning structures in accordance with the present disclosure;

FIG. 5A is an elevation view of a tensioning structure in accordance with the present disclosure;

FIG. 5B is an enlarged elevation view of a portion of the tensioning structure shown in FIG. 5A;

FIG. 5C is a cross-section view, taking along the line 5C-5C of FIG. 5B, of the tensioning structure shown in FIG. 5A;

FIG. 6 is a perspective view of a tensioning structure made in accordance with the present disclosure;

FIG. 7 is a cross-section, elevation view of a multifilament strand suitable for use in a tensioning structure made in accordance with the present disclosure, shown in an undeformed configuration;

FIG. 8 is a cross-section, elevation view of the multifilament strand shown in FIG. 7, shown in a deformed configuration between two weld strips;

FIG. 9 is a cross-section, elevation view of another multifilament strand suitable for use in a tensioning structure made in accordance with the present disclosure, shown in an undeformed configuration;

FIG. 10 is a cross-section, elevation view of another multifilament strand suitable for use in a tensioning structure made in accordance with the present disclosure, shown in an undeformed configuration;

FIG. 11 is a cross-section, elevation view of the multifilament strand shown in FIG. 10, shown in a deformed configuration between two weld strips;

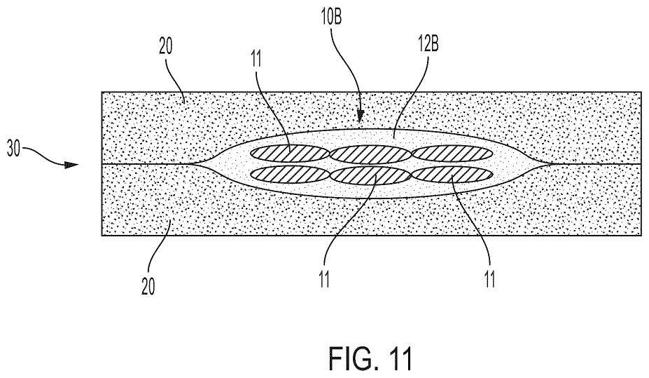

FIG. 12 is a perspective view of another tensioning structure made in accordance with the present disclosure;

FIG. 13 is a perspective view of another tensioning structure made in accordance with the present disclosure:

FIG. 14 is a perspective, partial cutaway view of an inflatable mattress incorporating tensioning structures in accordance with the present disclosure;

FIG. 15 is an enlarged perspective, partial cutaway view of a portion of the inflatable mattress of FIG. 12;

FIG. 16 is a perspective, cutaway view of another inflatable mattress made in accordance with the present disclosure, incorporating tensioning structures and corner braces made in accordance with the present disclosure:

FIG. 17 is a perspective, cutaway view of another inflatable mattress made in accordance with the present disclosure, incorporating tensioning structures and corner braces made in accordance with the present disclosure:

FIG. 18 is a perspective, exploded view of a bathing apparatus incorporating tensioning structures in accordance with the present disclosure;

FIG. 19 is a top plan view of the bathing apparatus shown in FIG. 18;

FIG. 20 is a side elevation, cross-section view of the bathing apparatus of FIG. 17, taken along the line 20-20 of FIG. 19;

FIG. 21 is a perspective view of an apparatus for producing tensioning structures made in accordance with the present disclosure;

FIG. 22 is a perspective view of another apparatus for producing tensioning structures made in accordance with the present disclosure; and

FIG. 23 is a perspective view of another apparatus for producing tensioning structures made in accordance with the present disclosure.

Corresponding reference characters indicate corresponding parts throughout the several views. Unless stated otherwise the drawings are proportional.

### DETAILED DESCRIPTION

The embodiments disclosed below are not intended to be exhaustive or to limit the invention to the precise forms disclosed in the following detailed description. Rather, the embodiments are chosen and described so that others skilled in the art may utilize their teachings. While the present disclosure is primarily directed to a tensioning structure used in inflatable products such as mattresses and bathing apparatuses, it is contemplated that the principles of the present disclosure may also be applied to other inflatable structures such as toys, watercraft, and the like.

For description of the embodiments in the present application, it should be understood that orientation or position, relative to gravity or a user, are indicated based on the orientation or position shown in the figures, and/or on the orientation or position as commonly used during service of the product, and/or on the orientation or position relations commonly understood by those skilled in the art. Orientations and positions are used to facilitate and simplify description of the present embodiments, but do not indicate or imply that such embodiment must define, or be used in, any specific orientation. Therefore, the embodiments described herein shall not be construed as limited to any orientation or position described herein.

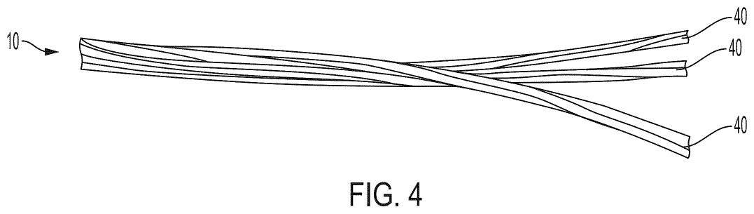

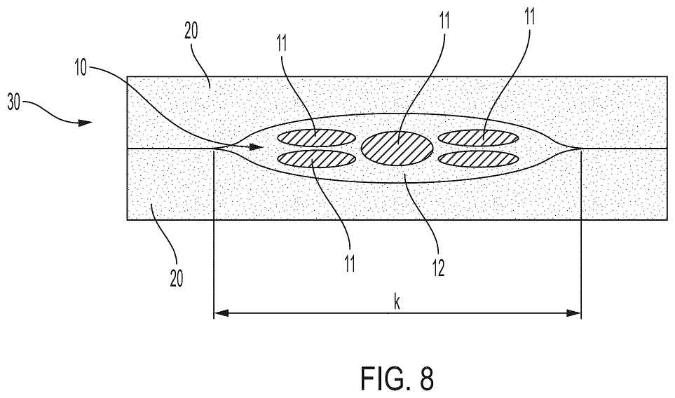

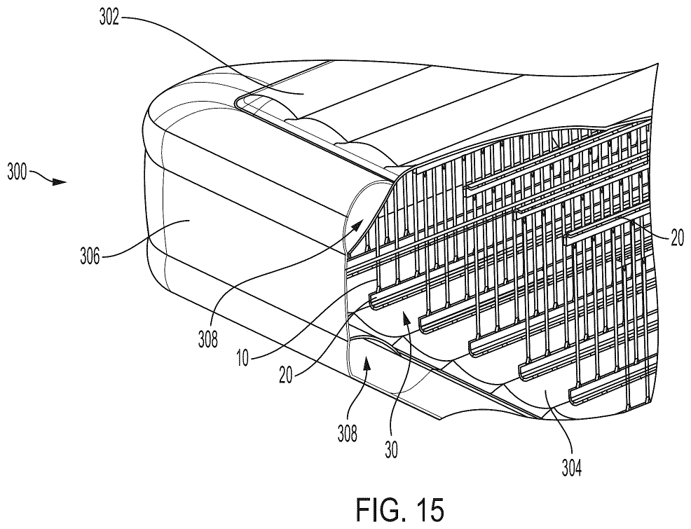

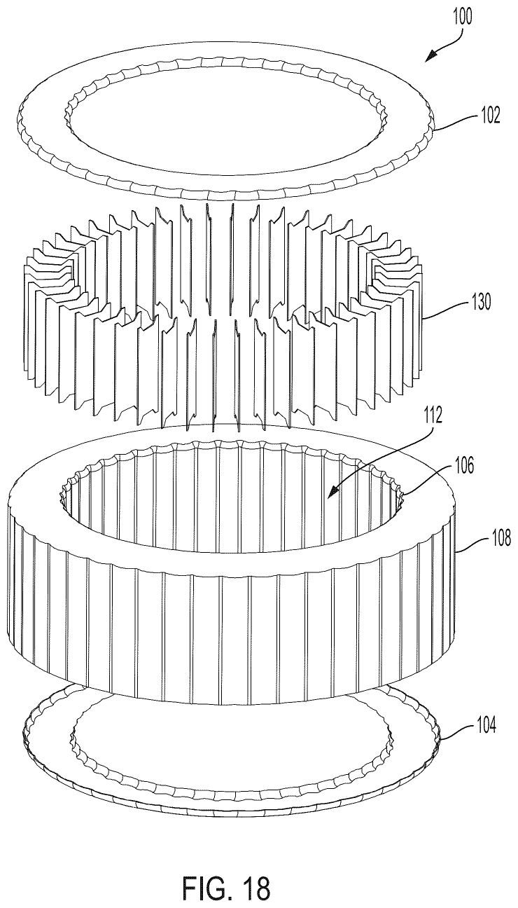

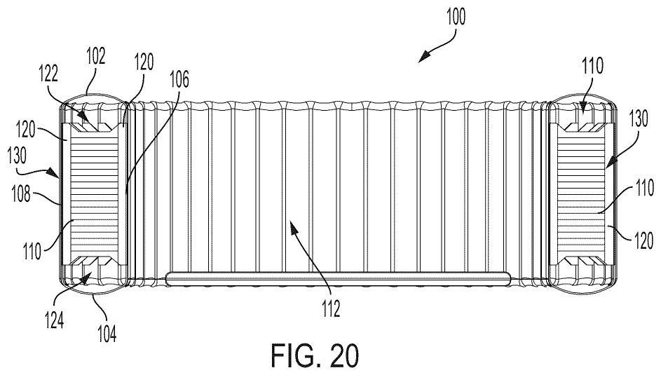

Turning now to FIGS. 4-6, the present disclosure provides a tensioning structure 30 useable within the inflatable chamber of an inflatable product, such as mattress (FIGS. 15-17) or a bathing enclosure (FIGS. 18, 20), for example. A plurality of tensioning structures 30 may be arrayed within the inflatable chamber of the inflatable product to impart and retain a desired shape during inflation and use, as further discussed below. Each of the tensioning structures includes at least two weld strips 20, which may be plastic strips made of the same or a different material compared to the sheets of material to which tensioning structures 30 attach. A plurality of strands 10 are arranged between the two weld strips 20, such that the plurality of strands 10 can be generally coplanar with the weld strips 20 when tensioning structure is laid flat, as occurs during manufacture for example. Of course, it is contemplated that weld strips 20 may have a bent, curved or folded configuration within the inflatable product when inflated, as further described below, for example. The weld strips 20 may be substantially parallel. The plurality of strands spanning the gap between the weld strips may each have substantially the same length as the others. This creates a generally rectangular finished tensioning structure 30, as shown in FIG. 8 for example.

For purposes of the present disclosure, “weld strips” and “weld sheets” are plastic strips or sheets which are designed and configured to be welded to one another or to other plastic weldable materials. A weld strip may be a strip which overlaps only an end portion of the strands 10. A weld sheet may be a sheet which overlaps most or all of the length of the strand 10. When welded, the structures become fixed by a weld, which denotes both the method by which they are fixed, and the nature of the welded material itself. That is, two plastic structures which are welded to one another to create a “welded” product is readily ascertainable as such by a person of ordinary skill in the art. Welded plastic products are identifiable by two structures with a common joinder that bears the appearance of a previously softened or melted material which has subsequently hardened and/or cured. Where additional structures such as strands 10 are embedded within the material, it is also readily apparent to a person of ordinary skill in the art that such embedded strands 10 can be embedded within and/or between sheet-like materials by a welding process, thereby creating a “welded” product. Welding may be accomplished by a combination of heat and pressure, such as with a high frequency welder or other thermofusion device as may be required or desired for a particular application.

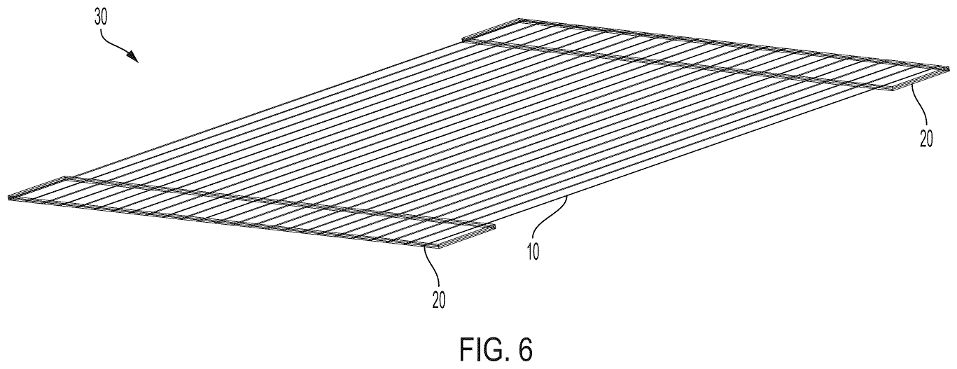

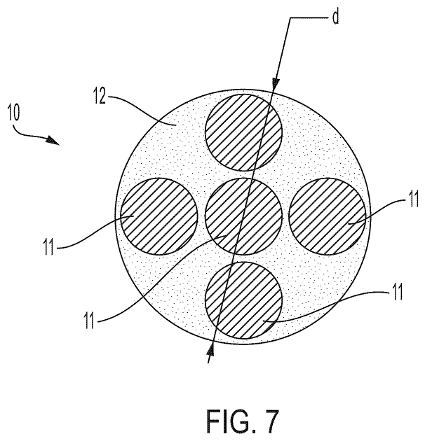

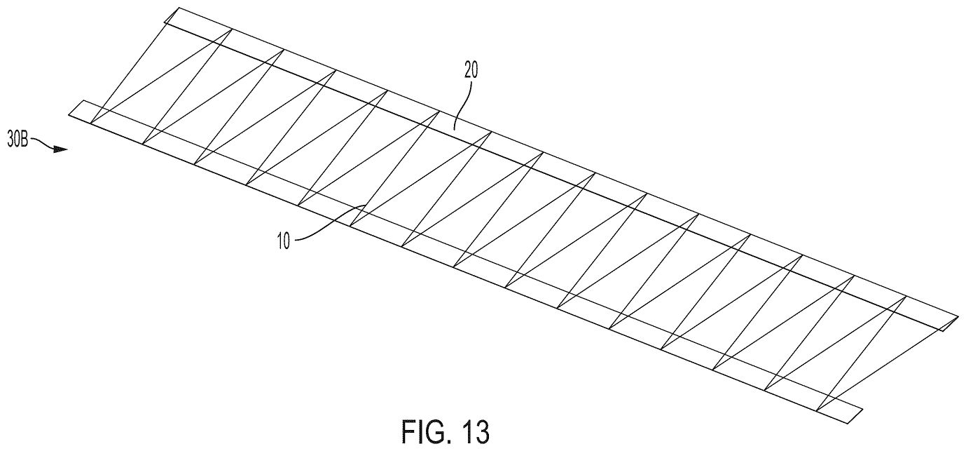

Each of the strands 10 within a given tensioning structure 30 is fixed to the weld strips 20. As shown in FIG. 6, strands 10 may be individual, discrete lengths of filament(s) 11 (see, e.g., FIG. 7) which are laterally spaced apart from one another along the length of weld strips 20. Strands 10 may be equally spaced apart and substantially parallel, as shown. Strands 10 may be woven together or otherwise interconnected as may be required or desired for a particular application. Strands may extend substantially perpendicular to longitudinal axes defined by weld strips 20, as shown. Strands 10 may alternatively be skewed somewhat away from perpendicular, such as by up to 15 degrees from perpendicular. However, each strand 10 extends entirely across the gap between two weld strips 20, as shown, with the respective opposing ends of strands 10 being fixed to one of the weld strips 20. Alternatively, the individual strands 10 may be interconnected, such as in a V-shaped configuration shown in FIG. 13 and described further below, with interconnected segments extending across the gap between the weld strips 20.

Weld strips 20 may have thicknesses ranging from 0.15 to 1.0 millimeters with 0.18 millimeters being preferred. Weld strips 20 may be 12.7 millimeters wide, for example, and may range from 1 to 100 millimeters wide. PVC may be used for weld strips 20. The PVC used for weld strips 20 may have a tensile strength ranging from at least 7 kgf/cm to 73 kgf/cm. The PVC used for weld strips 20 may have a density ranging from 0.8-2.5 grams per centimeter cubed. One exemplary density for the PVC of weld strips 20 may be 1.5 grams per centimeter cubed. Being made of PVC, weld strips 20 and the sheets to which they attach in various inflatable structures (described below) are integral, homogenous, non-fibrous, non-fabric material. During assembly of tensioning structure 30, strands 10 do not pierce weld strips 20, but are sandwiched between or otherwise embedded within the material of the respective of weld strips 20. The strands 10 may be affixed to at least one of the weld strips 20. The strands 10 may be affixed to both weld strips 20. The strands 10 may be affixed between the weld strips 20, such as by a chemical and/or mechanical bond to the weld strip material, as described herein. The strands 10 may be sandwiched between the weld strips 20, such that the strand 10 abut a surface of each or two weld strips 20, and the surfaces of those two weld strips 20 also abut one another. The strands 10 may be embedded within the material of each of the weld strips 20. For example, the material of the weld strips 20 may become molten during the welding process, and the strands 10 may sink or otherwise embed into the molten material, creating a chemical/mechanical bond between the strands 10 and weld strips 20.

Turning to FIG. 7, a cross-section of one of the strands 10 used in tensioning structures 30 is shown. Each strand 10 may be a multifilament structure including at least two (illustratively, five) filaments 11. Each filament 11 may itself contain multiple filament yarns. Filaments 11 may be twisted into a cable-like structure, as described further below, and may further include a binder or adhesive layer 12 which retains an intended configuration of filaments 11 relative to one another, and aids in fixation of strands 10 to strips 20 as also described further below. The filaments 11 may define a weight of 50 Decitex (dtex), it being understood that dtex is defined as the mass of strand 10 in grams per 10,000 meters of strand 10. The filaments 11 may be no greater than 1,000 dtex. Each strand 10 may have a denier of at least 50D, it being understood that denier is the mass of filament 11 in grams per 9,000 meters of filament 11. The denier of each strand 10 may be no greater than 2,500D. The overall diameter d (shown, e.g., in FIG. 7) of strand 10 may be at least 0.10 and no greater than 0.14 mm, i.e., about half of typical prior designs.

While FIG. 7 shows an undeformed configuration of strand 10, FIG. 8 shows a deformed configuration resulting from compression of an end portion of the strand 10 upon fixation to weld strip(s) 20. As shown in FIG. 8, the end portions of strands 10 may be compressed between two weld strips 20, such that the end portion of each strand 10 becomes captured between the weld strips 20. During this compression, the various filaments 11, and in some cases their yarns, are allowed to spread and splay apart and disperse. This effectively “flattens” the otherwise generally circular cross-section of strand 10 to define width k at the end portion between the weld strips 20, which is the maximum dimension of a cross-section of the strand 10 as measured generally along the adjacent surface of the weld strips 20. Width k is greater than the diameter d of the uncompressed, and therefore undeformed, portion of strand 10.

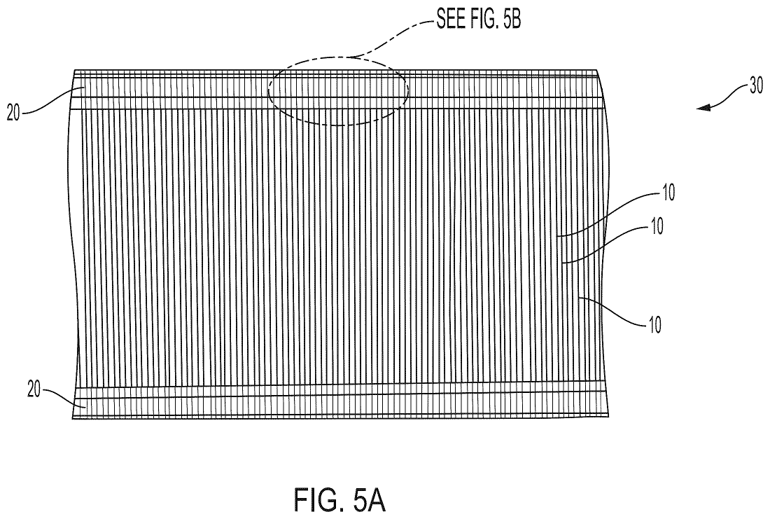

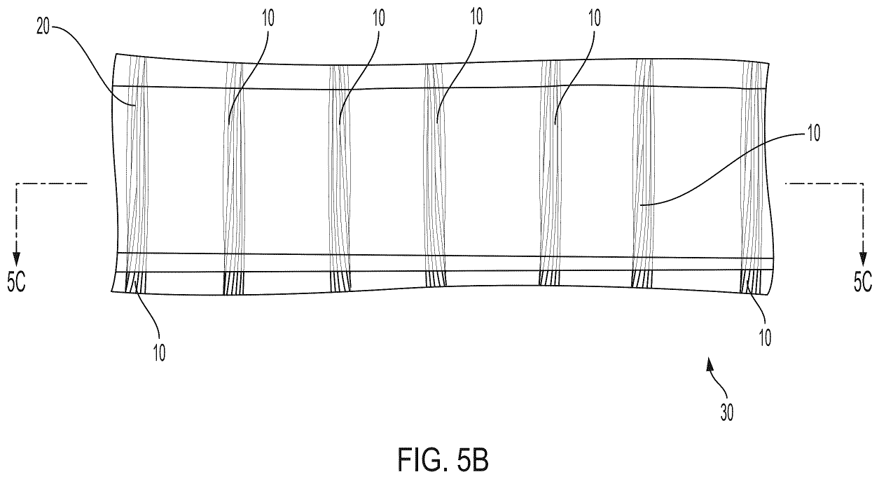

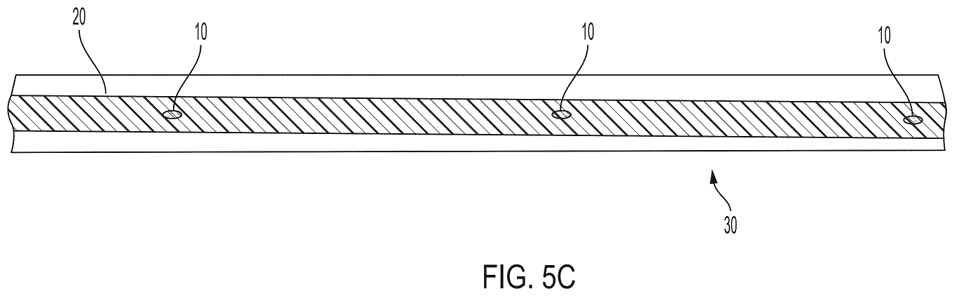

The increased width k results from the lateral or horizonal extension of filaments 11 along the adjacent surfaces of weld strips 20. Thus, filaments 11 are dispersed along this surface, which ensures that the various filaments 11 make maximum contact with the weld strips 20, thereby facilitating a secure fixation when weld strips 20 are softened or melted into contact with filaments 11 (FIGS. 5B and 5C). The width k of the strand 10 at the fixed position between the strand 10 and the weld strip 20 may be at least 1.2 times of the diameter d of the strand 10. The width k of the strand 10 at the fixed position between the strand 10 and the weld strip 20 may be no greater than 5.0 times of the diameter d of the strand 10.

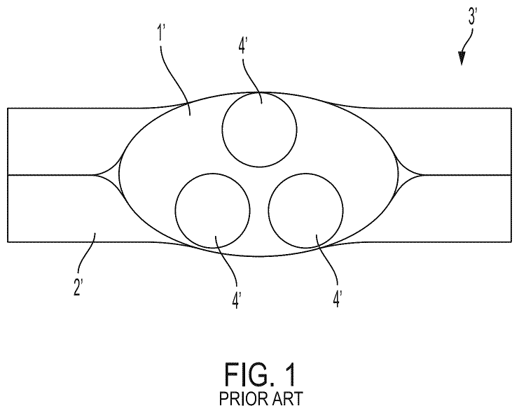

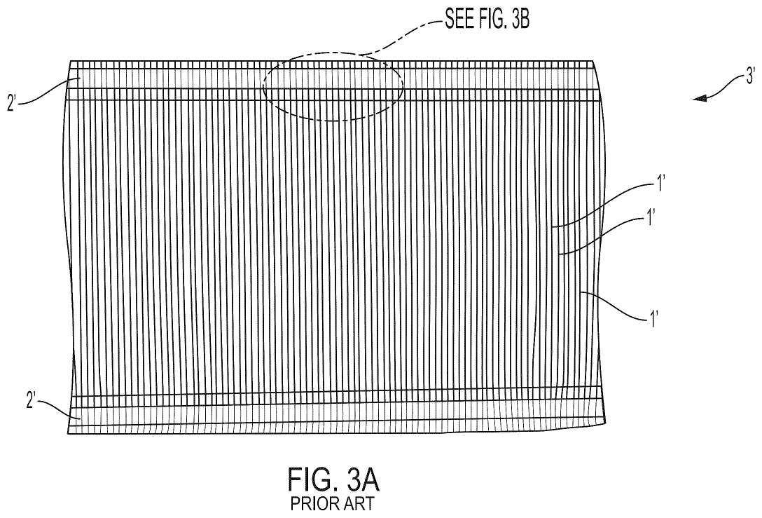

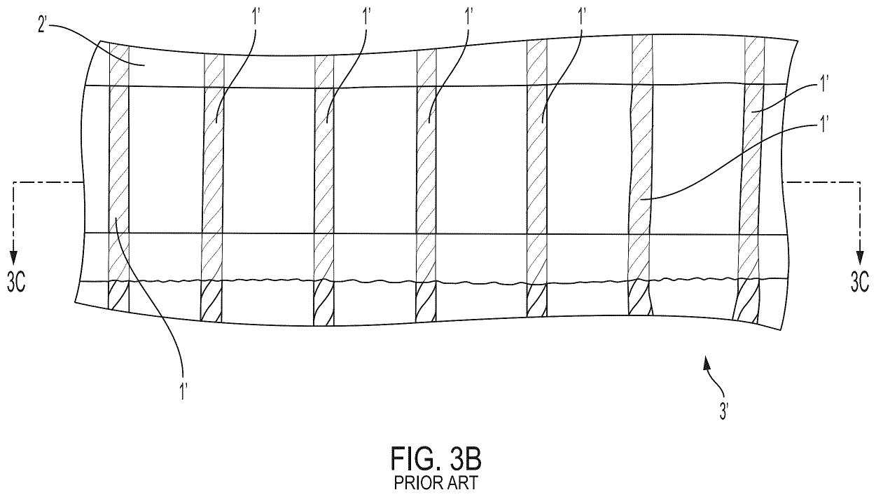

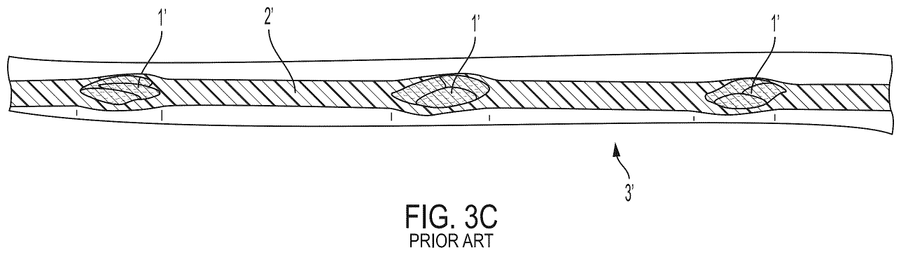

In addition, as best seen in comparisons of FIGS. 3B and 5B and FIGS. 3C and 5C, the dispersal and flattening of filaments 11 allows strand 10 to integrate securely within the material of weld strips 20, while leaving substantial additional material from weld strips 20 on either side of the finished tensioning structure. For example, FIGS. 3B and 3C illustrate bulges which form at the surface of the weld strip 20 (FIGS. 1 and 3C), resulting from the undispersed and larger-diameter strands 1′ used therein. This, in turn, can result a low wall thickness at the exterior surfaces of weld strips 2′ in the area where strands 1′ are fixed (FIG. 3B). This low wall thickness may, in turn, reduce the strength of the subsequent fixation between the tensioning structure 3′ and an adjacent sheet of an inflatable product, such as a mattress or spa. The smaller diameter of strands 10 and the dispersal of filaments 11 in tensioning structure 30, by contrast, results in no discernable bulging (FIG. 5B) and substantial remaining thickness of the weld strips 20 at the fixations locations for strands 10 (FIG. 5C). This facilitates greater strength of fixation between strands 10 and weld strips 20, as well as between weld strips 20 and an adjacent sheet of an inflatable product, as discussed in further detail below.

As best shown in FIG. 5C, a significant portion of the original thickness of weld strips 20 remains intact between the outer surface of the plastic strip and the nearest surface of the integrated strand 10. For example, at least half of the original thickness of the weld strip 20 may be left intact after strand 10 is integrated. Stated another way, the amount of material of the weld strip 20 remaining on either side of the integrated strand 10 may have a total thickness at least equal to the thickness of the thread body 10 at the fixed position (where the thickness of the thread body 10 is measured perpendicular to the width k shown in FIG. 8). In testing, the filaments 11 were shown to occupy about 20% of the overall thickness of the weld strips 20 (FIG. 5C), while the strands 1′ occupied more than 80% of the overall thickness of the weld strips 2′ (FIG. 3C).

Moreover, the filaments 11 of the strand 10 are only dispersed at the respective end portions of strands 10, where they are fixed to the weld strip 20. The remainder of the strand 10 remains in the undeformed state (as shown, e.g., in FIG. 7) which preserves the full strength of strand 10. This maximizes the tensile strength of the strands 10 across the gap between weld strips 20, ensuring adequate tensile strength for the overall tensioning structure 30 even when the gap is large (e.g., in tall inflatable mattresses).

Filaments 11 may be twisted to form a cable-like structure for the strand 10. Filaments 11 of strand 10 may include up to 50 twists per meter. In order to more effectively facilitate the flattening and dispersal of filaments 11 at the interface between the strand 10 and the weld strip 20, the twist may be allowed to unravel at the end portions of the strand.

Strand 10 may include an adhesive outside the strand 10 or outside each filament 11 of the strand, as further described below. The adhesive can be used to further strengthen the connection between the filaments 11 and the weld strip 20, thereby further improving the overall tensile strength of the tensioning structure 30. The adhesive may be heat-activated, such that the adhesive becomes molten and flowable at the same time that the weld strips 20 are welded, such that the adhesive is allowed to intermix and integrate with the plastic of the weld strips in the vicinity of the interface between the filaments and the adjacent weld strip 20. At the same time, if the filaments 11 are bound together by the adhesive (as in strands 10 and 10B described below), this binding is released by the melting or activation of the adhesive layer, allowing the filaments to be dispersed and clamped between the two weld strips 20 as described above. Thus, each filament 11 can be encapsulated between the weld strips 20. This encapsulation creates a strong mechanical fixation between the filaments 11 and the weld strips 20. Adhesive may additionally create a strong chemical fixation between the filaments and the weld strips 20. Adhesive may be applied to the weld strips 20, either in lieu of or in addition to adhesive coated on the strands 10 or filaments 11. For example, a strip of heat-activated adhesive may be applied to the surface of one or both of the weld strips 20 adjacent the strands 10, such that the adhesive becomes molten upon welding and is allowed to intermix and integrate with the filaments 11 of the strands 10. For purposes of the disclosure below, adhesive is discussed with reference to an adhesive layer applied to the strands, but it is understood that this disclosure also applies equally to an adhesive layer applied to at least one of the weld strips 20.

The thickness of the adhesive layer, such as layers 12, 12A or 12B all described below, may range from 0.01 to 0.5 mm depending on the application and the requirements of a particular design. Such thickness may range from 0.1-0.4 mm for example. Such thickness may range from 0.2-0.3 mm for example. The adhesive may be hot-melt glue, which requires heating to liquify and cooling to cure, or volatile glue, for example PVC cement or polyurethane (PU) adhesive, which can be applied at room temperature and allowed to cure via evaporation. The adhesive layer 12, 12A or 12B may be the same material or chemical composition as the weld strip 20 to which the filaments 11 and overall strand 10, 10A or 10B is fixed.

Turning to FIG. 7, strand 10 may be dipped in adhesive during manufacture to form an adhesive layer 12. Filaments 11 are first arranged next to one another to form a finished arrangement for strand 10, such as four satellite filaments 11 around a central filament 11 as shown. Twist, if desired, is applied to the filaments 11 as described herein. The finished strand 10 including all its filaments 11 is then dipped in molten or otherwise liquid adhesive to form an adhesive layer 12, i.e., the adhesive layer 12 is coated on the strand 10 and throughout the spaces around and between filaments 11. Once dried or cured, this adhesive layer 12 bonds the filaments 11 to one another. This bonding among the filaments 11 allows the degree of twist for the filaments 11 to be zero, i.e., the filaments may be simply aligned and parallel but not helically wound. As noted above, however, the degree of twist for the filaments 11 is set to be greater than zero, filaments 11 can be bound together with further strength and resilience, and the tensile strength of the strand 10 can be further improved.

For purposes of the present disclosure, filaments 11 may be considered to be “parallel” whether they are helically wound or simply aligned with no twist. When wound, the filaments 11 may be considered helically parallel, and when not wound, filaments may be considered to be linearly parallel.

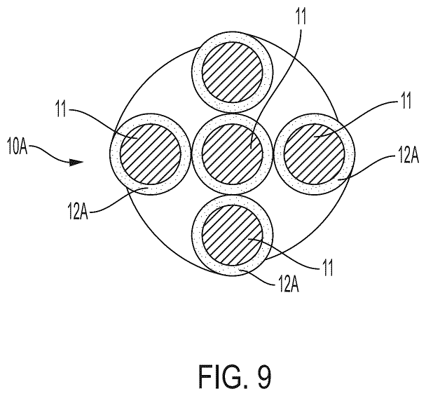

FIG. 9 shows an alternative arrangement of strand 10, shown as strand 10A, in which the adhesive layer 12 is applied to, and coated over, individual filaments 11 prior to being grouped into strands 10A, rather than being applied to the already-grouped filaments 11 as described above. In this construction, each filament 11 is independently dipped in molten or otherwise liquid adhesive, and then allowed to dry or cure. A resulting adhesive layer 12A is formed on the surface of each filament 11. These coated filaments 11 can then be mated to one another and twisted to form strand 10A. Because the filaments 11 are not bound to one another by adhesive layers 12A, the degree of twist among the filaments 11 is greater than zero, such as up to 50 as noted above, to ensure the filaments 11 remain bound together and thereby promote the overall desired tensile strength of strand 10.

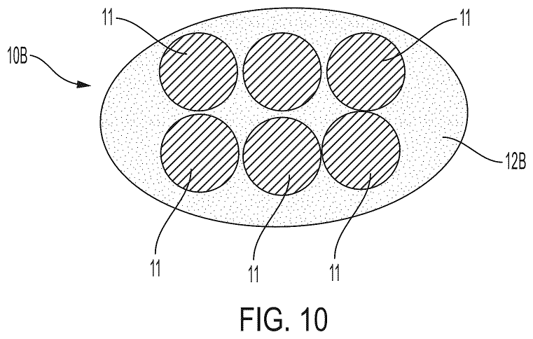

Turning now to FIG. 10, a strand 10 useable in a tensioning structure 30 made in accordance with the present disclosure is shown as strand 10B. The filaments 11 of the strand 10B can be arranged randomly or in a pattern, to form a columnar structure. Alternatively, filaments 11 can be arranged next to one another, to form a flat structure. For example, the filaments 11 of the strand 10 are arranged in parallel, to form an “M×N” array or pattern in cross section, where M is 1 or 2 representing the number of rows in the pattern, and N is the number of columns in the pattern. N may be 2 or more when M=1, and N is 1 or more when M=2. As shown in FIG. 10, a “2×3” pattern may be used with 2 rows of 3 filaments 11.

As with strands 10 and 10A discussed above, the yarns used for filaments 11 may be at least dtex. The filaments 11 may be no greater than 1,000 dtex. When M=1, a greater number of yarns per filament 11 may be used, and when M=2, lesser number of yarns per filament 11 may be used. Similarly, filaments 11 may be thinner overall where they are used in larger numbers, and thicker overall where they are used in smaller numbers to form a finished strand 10B. The finished strand 10B may have a denier of at least 50D. The finished strand 10B may have a denier of no greater than 2,500D.

Similar to strands 10 and 10A discussed above, the filaments 11 of strands 10B may be twisted, with a degree of twist among the filaments 11 being between 0 and 1,000 twists per meter. When there is no twist between the filaments 11 of the strand 10, the degree of twist is zero. When the filaments 11 are twisted, the degree of twist can be set to no more than 1,000 twists per meter, such as 90 twists per meter, 100 twists per meter, 300 twists per meter or 500 twists per meter, for example, or any number of twists per meter within any range defined by any pair of the foregoing values. When the filaments 11 of the strand 10 are twisted together, the filaments 11 can be mutually wound around one another. Alternatively, one of the filaments 11 can be used as the strand core, and the remaining filaments 11 can be wound with the strand core as the center. This type of winding, in which a core strand is included, is used to produce strands 10 and 10A if twist is employed.

Strand 10B may also include a layer of adhesive 12B, as shown in FIG. 10. Adhesive 12B may be applied as a single layer to the array of M×N filaments, similar to strand 10 described in detail above. Alternatively, each filament 11 in strand 10B may be individually applied with an adhesive, similar to strand 10A described above.

When any of the strands 10, 10A or 10B is connected with an adjacent weld strip 20, a respective adhesive layer 12, 12A or 12B facilitates a firm and strong fixation of the strand 10, 10A, 10B to the adjacent weld strip 20. In particular, and as noted above, the adhesive layer 12 provides an adhesive attachment between the filaments 11 and the adjacent material of a weld strip 20, ensuring firm and total connection between the surface of the filaments and the plastic material of the weld strip. This improves the connection stability between the strand 10 and the weld strip 20. Even where adhesive layer 12, 12A or 12B is used, however, the weld strips 20 may still be bonded to one another by hot-melt equipment such as a high-frequency machine or a hot press as described herein. That is, the adhesive layer 12 may promote even better bonding between the filaments 11 and the adjacent abutting portions of the weld strips 20, but a welding or other hot-melt process is still used to bond the weld strips 20 to one another, and to bond the weld strips 20 to other structures, such as mattress sheets as described below.

In addition to the optional use of adhesive as described above, weld strips 20 are fixed to strands 10, other weld strips 20, and adjacent structures by welding. Welding alone may be used, with no separate adhesive. Hot melting equipment, such as a hot press or a high frequency machine, may be used to soften and/or melt the plastic material of weld strips 20 (and heat-activated adhesive, if applicable), allowing softened or molten plastic to surround and encapsulate the filaments 11. Once the filaments are embedded within the softened or molten plastic material of weld strips 20, the hot melting equipment is deactivated to allow the weld strips 20 to set, harden and cure. At this point, the filaments 11 and strands 10 are considered fixed to the weld strips 20.

Tensioning structure 30 shown in FIG. 6 and described above may be produced with any of the strand designs discussed herein. Similarly, other tensioning structures may be made and used for inflatable products. For purposes of the present disclosure, a reference to strand 10 includes strands 10, 10A and 10B and their associated arrangements and structures, unless specifically noted to the contrary, for any of tensioning structure design made in accordance with the present disclosure.

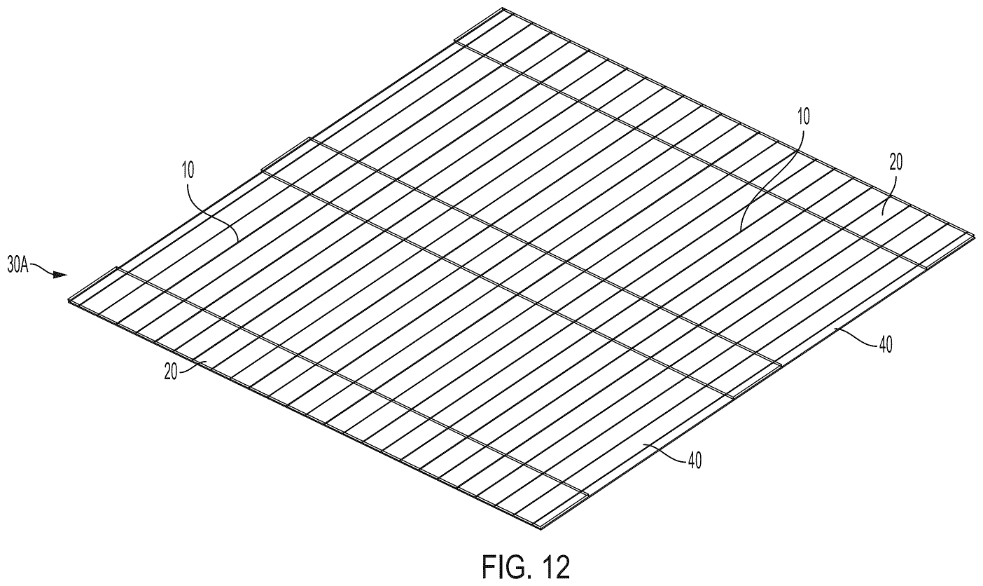

One additional tensioning structure design in accordance with the present disclosure is shown in FIG. 12. This design uses weld strips 20 on one side of the strands 10, and one or more weld sheets 40 on the other, opposing side of the strands 10. Weld sheets 40 may have a reduced thickness compared to weld strips 20, and may be used to retain strands 10 in a desired (e.g., parallel) orientation relative to one another even when the inflatable product is deflated. Thus, weld sheets 40 may be used not as a structural or tension-bearing structure, but rather, as a thin substrate to which strands 10 may be adhered or otherwise fixed. Weld sheets 40 may also be placed on both sides of strands 10 such that the strands 10 are captured therebetween.

FIG. 13 shows another tensioning structure 30B in which the strands 10 can be arranged in parallel, and also can be arranged to a shape of “V”. Specifically, the plurality of strands 10 are connected end to end to form a shape of “V”, and the upper and lower end portions of each “V” shaped strand 10 are fixed to upper and lower weld strips 20, respectively. Where it is desired for the strands to be parallel, a pair of corners may be fixed to the weld strips 20 rather than a single corner, such that the strands are connected end to end to form the shape of a “U”.

That is, strands 10 have a staggered, V-shaped arrangement, and may be formed from a single strand wound back and forth rather than a plurality of separate and discrete strands as used in tensioning structure 30 for example. As described below in the context of the method of manufacture of tensioning structure 30B, strand 10 may be a single, continuous strand woven between spaced-apart weld strips 20, with the point of each “V” affixed to at least one of the weld strips 20.

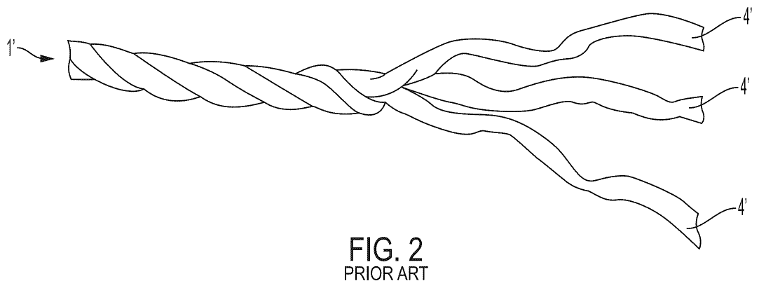

Tensioning structures made in accordance with the present disclosure, such as tensioning structures 30, 30A and 30B, were produced and tested against a control sample of prior fiber-based tensioning structures, including those shown in FIGS. 1-3C. As detailed below, tensioning structures made in accordance with the present disclosure exhibit substantial performance advantages compared to the control sample.

The strength of connection between the weld strips 20 and the adjacent sheet of an inflatable structure, such as material sheets 302 and 304, can be tested by attempting to “tear” or remove the tensioning structure 30 away from the adjacent sheet. Tensioning structure 30 was tested in this manner against a control tensioning structure 3′ as shown in FIGS. 3A-3C, to generate the following data:

| Welding | Control | Sample Strength | | Observed |
|---|---|---|---|---|
| Thickness | Sample | Made By Present | | Improvement |
| Ratio | Strength | Disclosure | | in Strength |
| 30% | 7.89 kgf/cm | 9.57 | kgf/cm | 21% |
| 45% | 9.02 kgf/cm | 9.87 | kgf/cm | 9% |
| 65% | 9.35 kgf/cm | 10.63 | kgf/cm | 14% |

In the table above, the “Welding Thickness Ratio” is the percentage of the overall thickness of the weld strips 20 which is made molten during the welding process.

As illustrated, all samples showed improvement over the control sample, with the strength of the thinnest weld of tensioning structure 30 exceeding the strength of even the thickest weld of tensioning structure 3′.

The strength of the weld between weld strips 20 and a single strand 10 shown in FIGS. 5A-5C was tested in tension, until failure. The control material is shown in FIGS. 3A-3C and was prepared in the same way. Weld strips 20 connected by a strand 10 endures 2.88 kgf before fracture, compared to 1.48 kgf for the control sample, showing a 95% improvement in the strength of the interface between the strand 10 and the weld strips 20 as compared to the control.

Fatigue strength also showed marked improvement. Again using tensioning structure 30 for testing and tensioning structure 3′ as a control sample, the strength of connection between the weld strips 20, 2′ and the strands 10, 1′ were tested after a series of identical tension cycles exerted on the tensioning structures 30, 3′. Tensioning structure 30 endured a 1.36 kgf load compared to a 0.28 kgf load for tensioning structure 3′, a 386% improvement.

Finally, a product performance test was performed on finished mattresses having either tensioning structure 30 within the inflatable chamber (i.e., in accordance with the design of mattress 300 described below), or with tensioning structure 3′ within an inflatable chamber of an otherwise identical mattress. A 1,300 N impact was delivered to the sleeping surface of each mattress until failure. The mattress including tensioning structure 30 withstood 820 impacts before developing a bulge-type failure, while the control mattress withstood 274 impacts before developing a leakage-type failure. This represents a 200% improvement together with a less-severe failure mode.

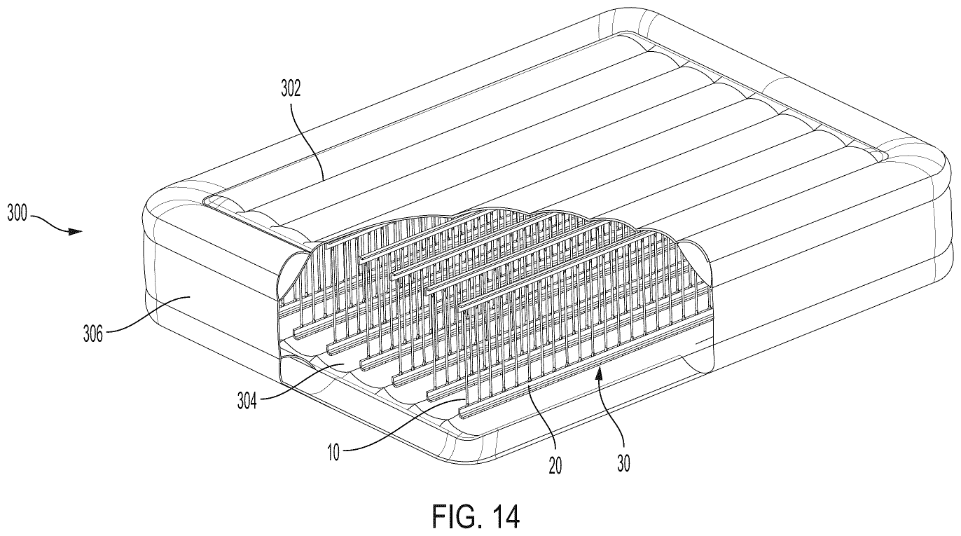

FIGS. 14-17 illustrate inflatable mattresses 300, 400, 500 incorporating tensioning structures made in accordance with the present disclosure.

FIG. 14 shows mattress 300 incorporating a number of tensioning structures 30 arrayed within the inflatable chamber of the mattress 300. Mattress 300 includes a sleeping surface defined or supported by an upper material sheet 302 and a ground-contacting surface defined or supported by a lower material sheet 304. An annular side band 306 is fixedly connected or welded to the peripheries of the upper sheet 302 and the lower sheet 304 to form the inflatable chamber. A valve (not shown) may be provided to facilitate inflation and deflation of the mattress 300.

FIG. 15 shows the arrangement of supporting structures within the inflatable chamber of the mattress 300 in greater detail. As illustrated, each tensioning structure 30 extends along the long dimension of the sleeping and ground-contacting surfaces, though tensioning structures 30 may also extend across the short dimension or in any other configuration, such as waves, columns, or the like. A lower weld strip 20 (or pair of weld strips 20) is folded, abutted to the inner surface of the lower sheet 304 along its length, and fixed (i.e., welded) to that inner surface along its length. Lower weld strip 20 may be folded 90 degrees. Similarly, an upper weld strip 20 (or pair of weld strips 20) is folded, abutted to the inner surface of the upper sheet 302 along its length, and fixed (i.e., welded) to that inner surface along its length. Upper weld strip 20 may be folded 90 degrees. A series of such weld strips 20 are welded across the width of mattress 300, thereby defining a ridged appearance of the upper and lower sheets 302 and 304 upon inflation.

When inflated, each set of strands 10 for each of the tensioning structures is placed into tension and spans the gap between the upper and lower sheets 302, 304, thereby cooperating with the annular side band 306 to give mattress 300 its characteristic rectangular cuboid outer shape. That is, the upper and lower weld strips 20 are respectively fixed to the upper and lower sheets 302, 304 to define a gap therebetween when the inflatable product is inflated.

As shown in FIG. 15, corner pockets 308 are also provided at the corners of the mattress 300, where the upper and lower sheets 302 and 304 meet the side band 306. An upper corner pocket 308 extends around the periphery of the upper sheet 302 and provides a raised or protruding “lip” around the sleeping surface which helps define and accentuate the edge of the sleeping surface. Similarly, a lower corner pocket 308 extends around the periphery of the lower sheet 304 and provides a raised or protruding “lip” around the ground-contacting surface that adds stability to the mattress 300. Corner pockets 308 are formed by a strip of plastic material, such as PVC, which is fixed to both the side band and one of the upper or lower sheets 302, 304. This strip of plastic material may have apertures or openings allowing it to receive inflation air from the main inflatable chamber of the mattress 300. The corner pockets 308 may be fluidly isolated from the main chamber and separately inflatable through a dedicated valve.

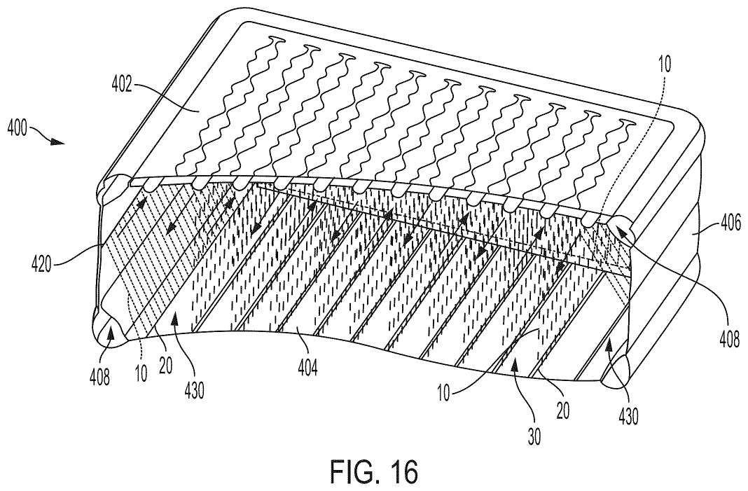

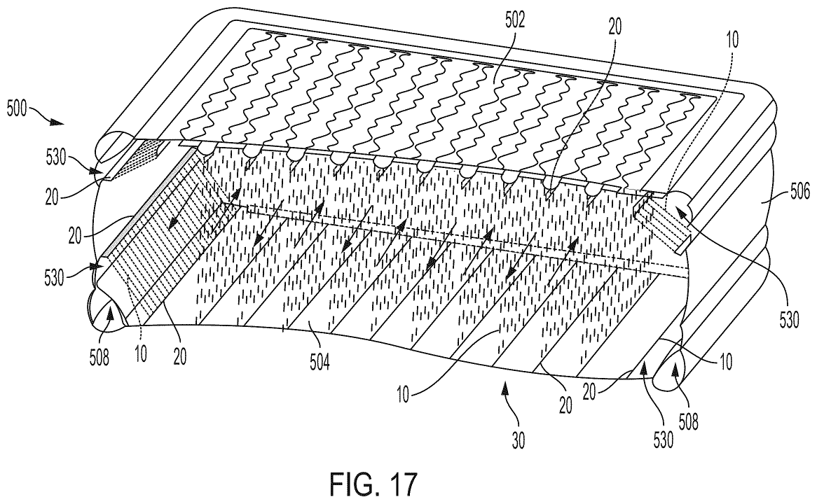

FIGS. 16 and 17 show additional mattress designs in accordance with the present disclosure. Mattresses 400 and 500 are constructed similarly to mattress 300, and common structures have common reference numerals, except with 100 or 200 added thereto. Moreover, mattresses 400 and 500 each utilize tensioning structures 30 which are constructed and deployed in the same manner as mattress 300 described above.

However, mattresses 400 and 500 use tensioning structures made in accordance with the present disclosure not just for the vertically-oriented connections between upper and lower sheets, but also for corner braces that help maintain the corner geometry of the finished mattress. Referring to FIG. 16, for example, mattress 400 includes corner braces 430 including weld strips 20 fixed to the bottom sheet 404 and the top sheet 402 in a similar fashion to the array of tensioning structures 30, as shown. Additionally, a third weld strip 420 connects strands 10 to the side band 406, such that the tension in the strands 10 operates to draw the middle of the side band 406 inwardly. This, in turn, promotes a more generally vertical orientation of side band 406 by preventing a bulge near its middle portion. This arrangement supports the use of a wider side band 406, allowing for a thicker mattress 400 and a higher sleeping surface of upper sheet 402.

Upper sheet 402 may also include a dual-layer construction such that the fixation of upper weld strips 20 of tensioning structures 30 and corner braces 430 is done on a lower surface of a lower layer of the dual-layer upper sheet 402, while the sleeping surface is an upper surface of the upper layer of the dual-layer upper sheet 402. Pressurized air may be allowed to flow into the space between the two layers, such as from the main inflatable chamber or through a separate valve.

Mattress 500, shown in FIG. 17, is constructed similarly to mattress 400, with reference numbers for the structures of mattress 500 being analogous to corresponding reference numbers of mattress 400, except with 100 added thereto. However, mattress 500 is an even thicker construction for an even taller sleeping surface. To accommodate this thickness and retain internal space for the array of tensioning structures 30, two separate and spaced-apart corner braces 530 are provided, as shown. Each corner brace 530 is fixed to the extra-wide side band 506 via a first weld strip, and to one of the upper or lower sheets 502, 504 via a second weld strip 20. Strands 10 span the gap between the weld strips 20 of corner braces 530, in the same manner as discussed herein with respect to tensioning structures 30, except that the angle of the fold in weld strips 20 of corner braces 530 may be about 45 degrees instead of about 90 degrees.

As noted above, other inflatable structures may also incorporate tensioning structures in accordance with the present disclosure. FIGS. 18-20 illustrate an inflatable bathing apparatus 100 incorporating tensioning structures 130 made in accordance with the present disclosure.

As shown in FIGS. 18-20, an inflatable pool 100 in accordance with the present disclosure includes a top wall or panel 102, a bottom wall or panel 104, inner surrounding or side wall 106, outer surrounding or side wall 108 and a plurality of tensioning structures 130. As discussed further below, tensioning structures 130 may be constructed in accordance with the above disclosure regarding tensioning structures 30, with minor modifications to account for the specific needs of the construction of inflatable pool 100.

The diameter of the outer side wall 108 is larger than that of the inner side wall 106, and the outer side wall 108 is sleeved around the inner side wall 106, creating a circular trough structure within the inner side wall 106. The outer side wall 108 surrounds and may be substantially concentric with the inner side wall.

The top wall 102 is annular, and is connected to the top edge of the inner side wall 106 and the top edge of the outer side wall 108. The bottom wall 104 is connected to the bottom edge of the inner side wall 106 and the bottom edge of outer side wall 108. An annular air chamber is defined by the top wall 102, the bottom wall 104, the inner or internal wall 106 and the outer or external wall 108. The pool 100 also includes a water cavity 112 formed by the bottom wall 104 and the internal wall 106.

The tensioning structures 130 are vertically arranged within the air chamber in an annular array manner, with weld strips 120 (FIG. 20) fixed (i.e., welded) to the inner wall 106 and the outer wall 108, in the same manner as other weld strips discussed herein. Strands 110, which may be constructed in the manner of any of the other strands discussed herein, including strands 10, span the radial gap between the inner and outer weld strips 120.

An upper gap 122 is formed between the top edge of the tensioning structures 130 and the top wall 102. A lower gap 124 is formed between the bottom edge of the tensioning structures 130 and the bottom wall 104. The gaps 122, 124 allow air to flow throughout the inflatable chamber during inflation and deflation, which may occur through one or more valves or vents (not shown). The air chamber may be inflated to a relatively high pressure greater than about 0.8 psi. For example, the air chamber may be inflated to a pressure of about 0.9 psi, 1.0 psi, 1.1 psi, 1.2 psi, 1.3 psi, 1.4 psi, 1.5 psi, 1.6 psi, or more. Such pressures may be about 1.5 or 2 times greater than pressures used to inflate traditional inflatable products. Inflatable mattresses, such as mattresses 300, 400 and 500, may also be inflated to these pressures, or to somewhat lower pressures such as 0.3 psi, 0.4 psi, 0.5 psi, 0.6 psi or 0.7 psi, for example.

As with tensioning structures 30 and similar to tensioning structure 30A in particular (FIG. 12), tensioning structures 130 may include one or more sheets may also be used between the weld strips 120 to bind the strands 110 into a predetermined arrangement, such as evenly spaced and substantially parallel as shown in FIG. 20. The tensioning structures 130 may enhance the strength of the pool 100, allowing the air chamber to withstand relatively high internal pressures, as discussed above, while also providing comfort a user sitting on or in pool or spa 100.

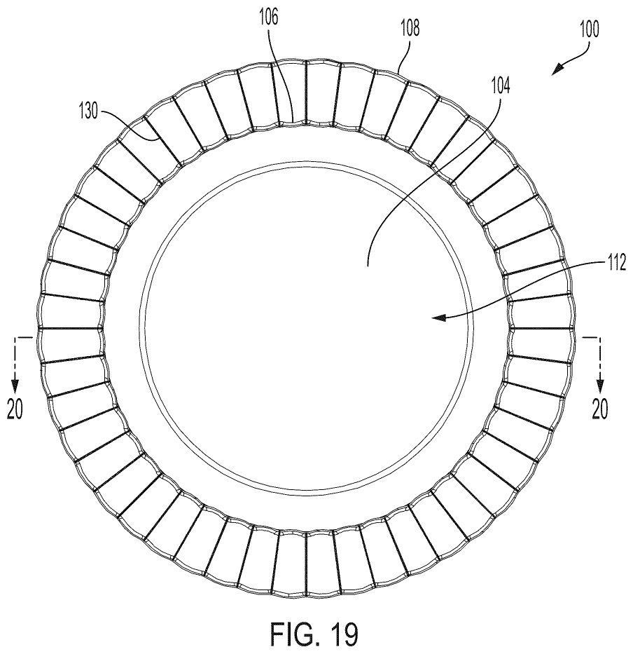

As shown in FIGS. 18 and 19, the tensioning structures 130 are arranged vertically and radially in the air chamber in an annular array pattern. As shown in FIG. 20, each tensioning structure 130 may be coupled to the internal wall 106 and the external wall 108, as discussed above.

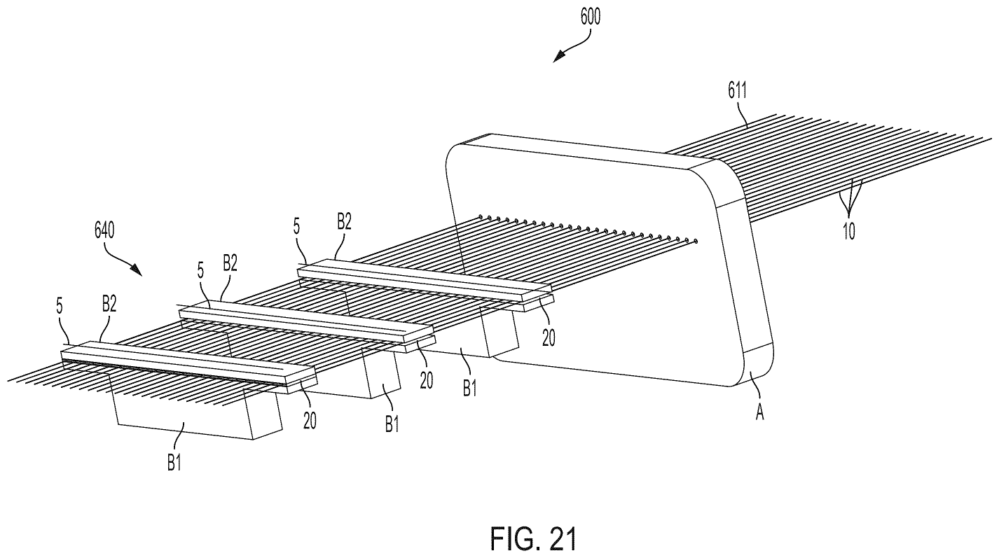

FIGS. 21-23 illustrate some exemplary hot melting apparatuses suitable for creating tensioning structure in accordance with the present disclosure. The operating frequency of the hot melting equipment is 10-40 MHz and the operating pressure intensity is 1 kgf/cm²-100 kgf/cm². These parameters can be used for bars or rollers, as further described below.

Turning now to FIG. 21, an apparatus 600 suitable for manufacturing tensioning structure 30 is shown. To operate apparatus 600 to this end, a plurality of strands 10 are provided from a bulk thread supply 611, which may be a yarn stand containing several spools of yarn for example. Thread supply 611 continuously delivers the plurality of strands 10 via strand guide A, which includes a plurality of apertures through which individual strands 10 pass after delivery from thread supply 611 and before incorporation into bulk tensioning structure material 30. Strand guide A may maintain uniform spacing of strands 10 relative to one another, and arranges strands 10 parallel to one another such that the plurality of strands 10 are substantially planar as shown. The width and length of weld strips 20, the distance between neighboring pairs of weld strips 20, and the spacing between neighboring pairs of strands 10 can be set to any values as required or desired by a particular design, such as in a particular inflatable product.

These planar, parallel and evenly-spaced strands 10 are then passed in to welder 640, as shown in FIG. 21 Welder 640 may be a thermofusion device, using heat to join two plastic materials together, or may be a high-frequency welder, in which electromagnetic waves take advantage of excitable chemical dipoles in the plastic material to soften and join the materials to one another. Moreover, any suitable welding method may be employed by welder 640, as required or desired for a particular material or process.

Weld strips 20, having a length corresponding to the width of the arranged plurality of strands 10, are positioned on lower dies B1 of welder 640. Strands 10 are advanced over weld strips 20 as illustrated, and upper dies B2 are then lowered into contact with weld strips 20. Energy (i.e., heat and/or electromagnetic waves) is applied to fixedly connect the weld strip 20 with each of the plurality of strands 10 such that the respective strands 10 are fixed in the spaced apart and parallel configuration dictated by strand guide A. When so fixed, bulk material including multiple interconnected tensioning structures 30 is complete and ready for use.

This finished bulk material may then be delivered to a take-up device (not shown), such as a spool or roll. This allows the bulk material to be continuously produced and stored for later use. The bulk material can be converted into tensioning structures, such as tensioning structure 30 (FIG. 6) by cutting down the center of weld strip 20. Tensioning structure 30 can then be applied to various inflatable products by trimming the length and width thereof according to the desired dimensions of the product.

Reinforcement strand 5 may be added to tensioning structure 30 to further improve the strength thereof, including the tensile strength of weld strips 20. To add at least one reinforcement strand 5 to tensioning structure 30, reinforcement strands 5 are arranged perpendicular to the plurality of strands 10, and abutting the respective weld strips 20. Upper die B2 of welder 640 is pressed down to fixedly connect the weld strips 20 to both reinforcement strands 5 and the plurality of strands 10, as described above.

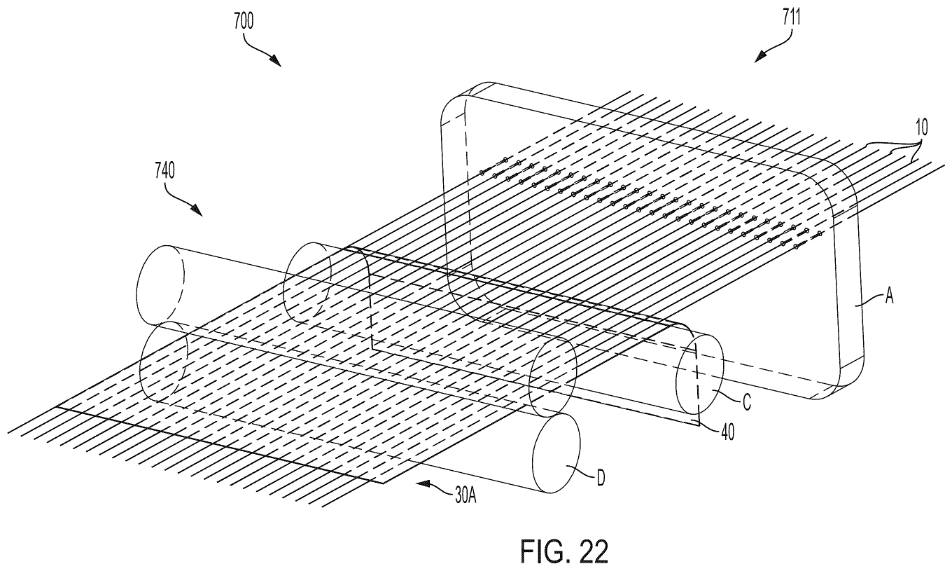

Turning now to FIG. 22, another apparatus 700 suitable for manufacturing tensioning structures made in accordance with the present disclosure is shown. Operation of apparatus 700 is accomplished by first supplying a plurality of strands 10 from a yarn stand or other stock of yarn, as described above with respect to apparatus 600. Strands 10 are continuously delivered via strand guide A, described above, which provides uniformly spaced apart and parallel strands 10 to the downstream welder 740.

Welder 740 includes a conveying roller C downstream of strand guide A, which continuously delivers a weld sheet 40 of width sufficient to correspond to the width of the plurality of strands 10. As noted above with respect to, e.g., tensioning structure 30A, weld sheet 40 may be used in some applications to maintain a set spacing and geometry of strands 10 regardless of whether the inflatable product to which they are attached is inflated or deflated. Downstream of roller C, the plurality of strands 10 are near to or abutting weld sheet 40.

The plurality of strands 10 and weld sheet 40 then advance together through hot roller D, which heats and compresses the material such that strands 10 become fixed to the softened material of weld sheet 40. After passage through roller D, the tensioning structure, such as tensioning structure 30A, is partially completed and may have weld strips 20 applied as detailed herein. Alternatively, bulk sheet-backed material for tensioning structure 30A may be wound onto a take-up spool for later cutting and processing as appropriate for a particular application.

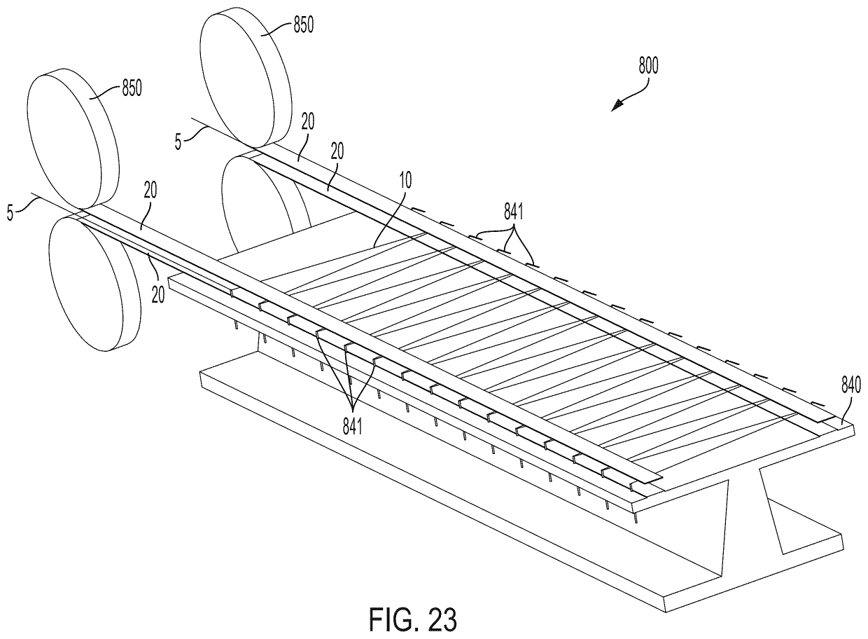

Turning now to FIG. 23, an apparatus 800 suitable for manufacturing tensioning structure 30B is shown. Operation of apparatus 800 is accomplished by disposing a lower pair of weld strips 20 such that the lower pair are substantially parallel and spaced apart upon joining device 840. Weld strips 20 may be unspooled from rolls of weld strip material contained within a pair of unreeling devices 850.

Next, continuous strand 10 is wrapped successively around a set of adjacent hook-shaped members 841 disposed at either side of joining device 840, with the plurality of hook-shaped members 841 arranged in two respective rows corresponding to the location of the previously-placed lower pair of weld strips 20. Hook-shaped members 841 may be uniformly spaced from one another and arranged at the outer sides of lower pair of weld strips 20, with each row of hook-shaped members 841 offset with respect to the other row. With this arrangement, the continuous strand 10 forms a plurality of end-to-end “V” shaped strands when wrapped around successive hook-shaped members 841 in alternating rows thereof, as shown. That is to say, the corner of each “V” is formed at a respective hook-shaped members 841, and successive corners traced along continuous strand 10 will alternate between rows of hook-shaped members 841. Where it is desired to have strands 10 extend straight across the gap between the weld strips 20 (i.e., a “U” shaped arrangement as described above), the corners may be traced over two of the pins 841 instead of a single pin 841.

Next, a second pair of weld strips 20 are positioned over the first pair of weld strips 20, respectively, and are clamped thereto such that each “V” shaped corner formed by strand 832 is disposed between one of the first pair of weld strips 20 and the abutting one of the second pair of weld strips 20. The second pair of weld strips 20 may also be unspooled from unreeling devices 850.

Finally, the abutting pairs of weld strips 20 are joined to one another and to strand 10, such as by welding or by one of the other attachment methods discussed above. For example, weld strips 20 may be joined by a high frequency welder or another thermofusion device.

As with other tensioning structures discussed above, tensioning structure 30A may be produced and stored in bulk and later applied to various inflatable products. The length and width of tensioning structure 30A may be trimmed to accommodate the internal length or width of the inflatable product.

Additional details of inflatable products and tensioning structures may be found in International Patent Application No. WO 2013/130117, filed Jun. 12, 2012 and entitled INTERNAL TENSIONING STRUCTURE USABLE WITH INFLATABLE DEVICES and International Patent Application No. WO 2015/085227, filed Dec. 5, 2014 and entitled INFLATABLE POOL, and International Patent Application No. WO 2019/116312, filed Jun. 20, 2019 and entitled PRODUCING AN INFLATABLE PRODUCT. The entire disclosures of all the foregoing references are hereby expressly incorporated herein by reference. The tensioning structures disclosed herein may be used in combination with any combination of the features disclosed in these incorporated applications.

While this invention has been described as having an exemplary design, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

1. A tensioning structure for an inflatable product, comprising:
a first weld strip;
a second weld strip spaced from the first weld strip to define a gap therebetween;
a plurality of strands arranged between the first and second weld strips and spanning the gap, the plurality of strands each have a first end portion fixed to the first weld strip and a second, opposing end portion fixed to the second weld strip, wherein
each of the plurality of strands includes at least two filaments, and each of the filaments includes at least two yarns, and
each of the plurality of strands has an undeformed portion spanning the gap between the first and second weld strips and a deformed portion at the first and second end portions, the undeformed portion defining a strand diameter and the deformed portion defining a width that is greater than the strand diameter.

2. The tensioning structure of claim 1, wherein the width of the strand at the first and second ends portions is between 1.2 and 5.0 times the strand diameter.

3. The tensioning structure of claim 1, wherein the filaments are parallel to one another in the undeformed portion and dispersed in the deformed portion.

4. The tensioning structure of claim 1, wherein the second weld strip is substantially parallel to the first weld strip, and the plurality of strands each have a substantially equal length.

5. The tensioning structure of claim 1, wherein the plurality of strands and the first and second weld strips are generally coplanar when the tensioning structure is laid flat.

6. The tensioning structure of claim 1 wherein at least some of the filaments are helically parallel, and a degree of twist between the helically parallel filaments is up to 50 twists per meter.

7. The tensioning structure of claim 1, wherein the strand and the weld strip form a welded product.

8. The tensioning structure of claim 1, further comprising an adhesive layer configured to become molten and flowable when the weld strips are fixed to the plurality of strands.

9. The tensioning structure of claim 8, wherein the adhesive layer is applied to at least one of the first the weld strip and the second weld strip.

10. The tensioning structure of claim 8, wherein the adhesive layer is coated over the strand.

11. The tensioning structure of claim 8, wherein the filaments are linearly parallel, such that a twist degree between the filaments is zero.

12. The tensioning structure of claim 8, wherein the adhesive layer is coated individually on each of the filaments.

13. The tensioning structure of claim 8, wherein the filaments are wound, such that at least some of the filaments are helically parallel.

14. The tensioning structure of claim 1, wherein the filaments define between 50 and 1,000 Decitex (dtex).

15. The tensioning structure of claim 1, wherein each of the plurality of strands has a denier between 50 and 2,500.

16. The tensioning structure of claim 8, wherein the adhesive layer is hot-melt glue.

17. The tensioning structure of claim 8, wherein the adhesive layer is volatile glue.

18. The tensioning structure of claim 17, wherein the adhesive layer is one of PVC cement or PU adhesive.

19. The tensioning structure of claim 1, wherein the plurality of strands are evenly spaced and substantially parallel.

20. The tensioning structure of claim 1, wherein the plurality of strands are connected end to end to form a shape of “V”, and the upper and lower parts of each “V” shape strand are fixed together with the first and second weld strips, respectively.

21. The tensioning structure of claim 1, further comprising a weld sheet having the plurality of strands fixed to a surface of the weld sheet along the undeformed portion.

22. The tensioning structure of claim 1, wherein the filaments of the strand are arranged in parallel to form an M×N array, where M and N are each integers equaling 1 or more.

23. The tensioning structure of claim 22, wherein:
M equals 1 or 2,
N≥2 when M=1, and
N≥1 when M=2.

24. The tensioning structure of claim 22, wherein the filaments are twisted and helically parallel, with a degree of twist up to 1,000 twists per meter.

25. The tensioning structure of claim 22, wherein filaments are linearly parallel.

26. The tensioning structure of claim 22, wherein the filaments define between 50 and 1,000 Decitex (dtex).

27. The tensioning structure of claim 22, wherein each of the plurality of strands has a denier between 50 and 2,500.

28. The tensioning structure of claim 19, wherein the strand further comprises an adhesive layer configured to become molten and flowable when the weld strips are fixed to the plurality of strands, a thickness of the adhesive layer is between 0.01 mm and 0.5 mm.

29. A method of making a tensioning structure, comprising:
abutting a first end portion of each of a plurality of strands against a first weld strip;
abutting a second, opposing end portion of each of the plurality of strands against a second weld strip spaced from the first weld strip to define a gap therebetween;
compressing the first end portion and the second end portion of the strands against the first weld strip and the second weld strip respectively; and
heating the weld strips and the compressed first and second end portions of the plurality of strands to fix the first and second end portions to the first and second weld strips respectively,
wherein at least one of the steps of compressing and heating causes multiple filaments of the first and second end portions of the strands to deform and disperse, such that the first and second end portions define a width larger than an undeformed portion of each of the strands spanning the gap.

30. The method of claim 29, wherein the plurality of strands each includes an adhesive layer, and the step of heating the weld strips also heats the adhesive layer such that the adhesive layer intermixes and integrates with the material of the weld strips in the vicinity of the interface between the filaments and the adjacent weld strip surface.

31. The method of claim 29, wherein at least one of the weld strips includes an adhesive layer, and the step of heating the weld strips also heats the adhesive layer such that the adhesive layer intermixes and integrates with the material of the strands in the vicinity of the interface between the filaments and the adjacent weld strip surface.

32. The method of claim 29, wherein a width of the deformed portion of each of the strands is between 1.2 and 5.0 times a diameter of the undeformed portion of the strand.

33. The method of claim 29, wherein the filaments are parallel to one another in the undeformed portion and dispersed in the deformed portion.

34. The method of claim 29, wherein the step of heating includes activating a welder to soften or melt the weld strips.

35. The method of claim 34, wherein the welder has an operating frequency between 10 MHz and 40 MHz.

36. The method of claim 29, wherein the step of compressing comprises creating an operating pressure intensity between 1 kgf/cm² and 100 kgf/cm² on the weld strips and the end portions of the plurality of strands.
